(19) United States
(12) Patent Application Publication
(10) Pub. No.: US 2024/0334171 A1
(43) Pub. Date: Oct. 3, 2024

(54) ENHANCEMENTS FOR EMERGENCY COMMUNICATION SERVICES IN NEXT GENERATION WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/607,274

(22) Filed: Mar. 15, 2024

Related U.S. Application Data
(60) Provisional application No. 63/455,716, filed on Mar. 30, 2023.
(60) Provisional application No. 63/455,750, filed on Mar. 30, 2023.

(51) Int. Cl. H04W 4/90; H04W 12/06; H04W 74/08

(52) U.S. Cl. CPC H04W 4/90; H04W 12/06; H04W 74/08

(57) ABSTRACT

A wireless communication network includes an access point (AP) device, the AP device may receive an emergency preparedness communication services (EPCS) authorization status for one or more station (STA) devices; and transmit a frame including the EPCS authorization status to the one or more STA devices, wherein the frame has higher priority for transmission than a frame for non-EPCS.

### CROSS-REFERENCE TO RELATED APPLICATIONS

This application claims the benefit of priority from U.S. Provisional Application No. 63/455,716, entitled “FAST AUTHORIZATION UPDATE FOR EPCS IN NEXT GENERATION WI-FI NETWORKS,” filed Mar. 30, 2023, and U.S. Provisional Application No. 63/455,750, entitled “SERVICE DEFINITION FOR EPCS TRAFFIC IN NEXT GENERATION WI-FI NETWORKS” filed Mar. 30, 2023, which are incorporated herein by reference in their entirety.

### TECHNICAL FIELD

This disclosure relates generally to a wireless communication system, and more particularly to, for example, but not limited to, enhancements for emergency communication services in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

Emergency telecommunication services have been implemented in a number of countries with the objective of providing prioritized access in the times of disasters or emergencies. Examples of such telecommunication services in the United States include Government Emergency Telecommunication Service (GETS), Wireless Priority Service (WPS), Next Generation Network priority services (NGN priority services), Telecommunications Service Priority (TSP), among others. Such services have also been implemented in several countries. Examples of such services include Blue Light Mobile Service in Belgium, Mobile Telecommunications Privileged Access Scheme (MTPAS) in Great Britain, disaster priority telephone in Japan, among others. Typically, such services are subscription based, operator controlled, enabled through global standards, and are offered over commercial network infrastructure.

The description set forth in the background section should not be assumed to be prior art merely because it is set forth in the background section. The background section may describe aspects or embodiments of the present disclosure.

### SUMMARY

One aspect of the present disclosure provides an access point (AP) device in a wireless network, the AP device comprising a memory and a processor coupled to the memory. The processor is configured to receive an emergency preparedness communication services (EPCS) authorization status for one or more station (STA) devices. The processor is configured to transmit a frame including the EPCS authorization status to the one or more STA devices, wherein the frame has higher priority for transmission than a frame for non-EPCS.

In some embodiments, the Enhanced Distributed Channel Access (EDCA) parameters of the frame including the EPCS authorization status have a higher priority than EDCA parameters of the frame for non-EPCS.

In some embodiments, the frame including the EPCS authorization status is simultaneously transmitted to the one or more STA devices.

In some embodiments, the EPCS authorization status indicates accessibility to the EPCS for the one or more STA devices.

In some embodiments, the processor is configured to locally store the EPCS authorization status and transmit the EPCS authorization status to one or more other AP devices.

In some embodiments, the processor is configured to advertise, to the one or more STA devices, a capability to simultaneously update EPCS authorization status for multiple STA devices.

In some embodiments, the processor is configured to receive classification criteria that classify EPCS traffic from non-EPCS traffic from an STA device, and transmit a frame including EPCS traffic to the STA device, wherein the frame has a higher priority for transmission than a frame for non-EPCS traffic.

In some embodiments, the classification criteria comprise a traffic identifier (TID) or a service identifier.

In some embodiments, the EPCS authorization status is received from an EPCS service provider.

One aspect of the present disclosure provides a station (STA) device in a wireless network. The STA device comprises a memory and a processor coupled to the memory. The processor is configured to receive a frame including an EPCS authorization status from an access point (AP) device, wherein the frame has higher priority than a frame for non-EPCS. The processor is configured to determine the EPCS authorization status enables access to the EPCS. The processor is configured to transmit a frame that includes EPCS traffic to the AP device, wherein the frame has higher priority for transmission than a frame for non-EPCS traffic.

In some embodiments, the Enhanced Distributed Channel Access (EDCA) parameters of the frame including the EPCS traffic have a higher priority than EDCA parameters of the frame for non-EPCS traffic.

In some embodiments, the processor is configured to receive another frame including an updated EPCS authorization status from the AP device, wherein the updated EPCS authorization status disables access to the EPCS, and transmit frames that has the same priority for transmission as the frame for non-EPCS traffic.

In some embodiments, the processor is configured to transmit classification criteria that classify EPCS traffic from non-EPCS traffic to the AP device.

One aspect of the present disclosure provides a computer-implemented method for facilitating communication in a wireless network. The method comprises receiving an emergency preparedness communication services (EPCS) authorization status for one or more station (STA) devices. The method comprises transmitting a frame including the EPCS authorization status to the one or more STA devices, wherein the frame has higher priority for transmission than a frame for non-EPCS.

In some embodiments, Enhanced Distributed Channel Access (EDCA) parameters of the frame including the EPCS authorization status have a higher priority than EDCA parameters of the frame for non-EPCS.

In some embodiments, the frame including the EPCS authorization status is simultaneously transmitted to the one or more STA devices.

In some embodiments, the EPCS authorization status indicates accessibility to the EPCS for the one or more STA devices.

In some embodiments, the method further comprises locally storing the EPCS authorization status, and transmitting the EPCS authorization status to one or more other AP devices.

In some embodiments, the method further comprises advertising, to the one or more STA devices, a capability to simultaneously update EPCS authorization status for multiple STA devices.

In some embodiments, the method further comprises receiving classification criteria that classify EPCS traffic from non-EPCS traffic from the at least one STA device, and transmitting a frame including EPCS traffic to the at least one STA devices, wherein the frame has a higher priority for transmission than a frame for non-EPCS traffic.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example Emergency Preparedness Communication Services (EPCS) communication in accordance with an embodiment.

FIG. 5 a flow chart of an example process for unicast authorization status updates in accordance with an embodiment.

FIG. 6 shows a flow chart of an example process of an AP MLD updating the EPCS authorization status in accordance with an embodiment.

FIG. 7 shows a flow chart of an example process of a non-AP MLD receiving update frames from an EPCS AP MLD to update its EPCS authorization status in accordance with an embodiment.

FIG. 8 shows a flow chart of an example process for a local cache update for an AP MLD in accordance with an embodiment.

FIG. 9 a flow chart of an example process for an AP MLD to advertise a capability regarding supporting updates to EPCS status of multiple non-AP STAs.

FIG. 10 shows a flow chart of an example process on a non-AP MLD providing classification criteria in accordance with an embodiment.

FIG. 11 shows a flow chart of an example process of an AP using classification criteria to differentiate traffic in accordance with an embodiment.

FIG. 12 shows a flow chart of an example process of an AP MLD updating classification criteria in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

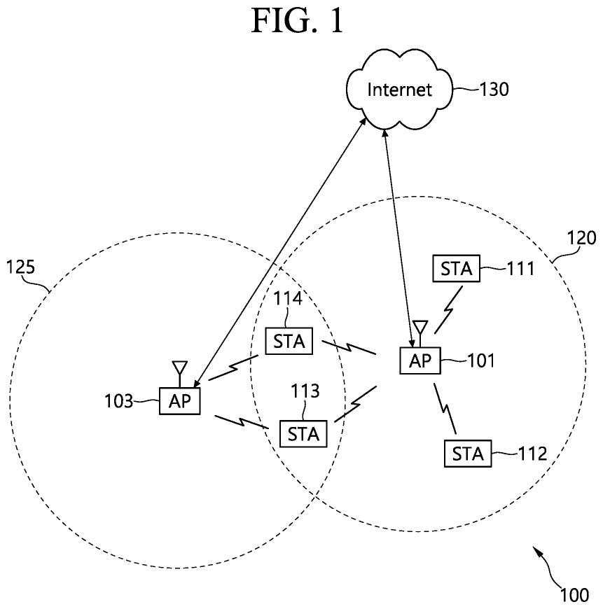

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

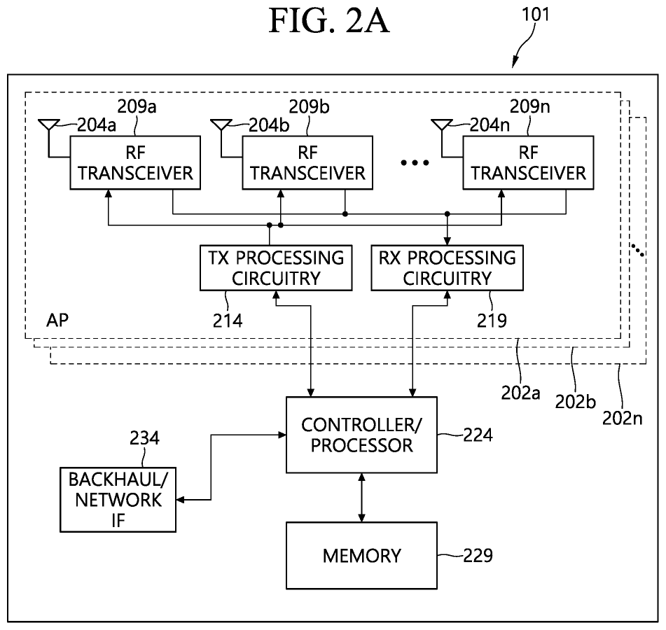

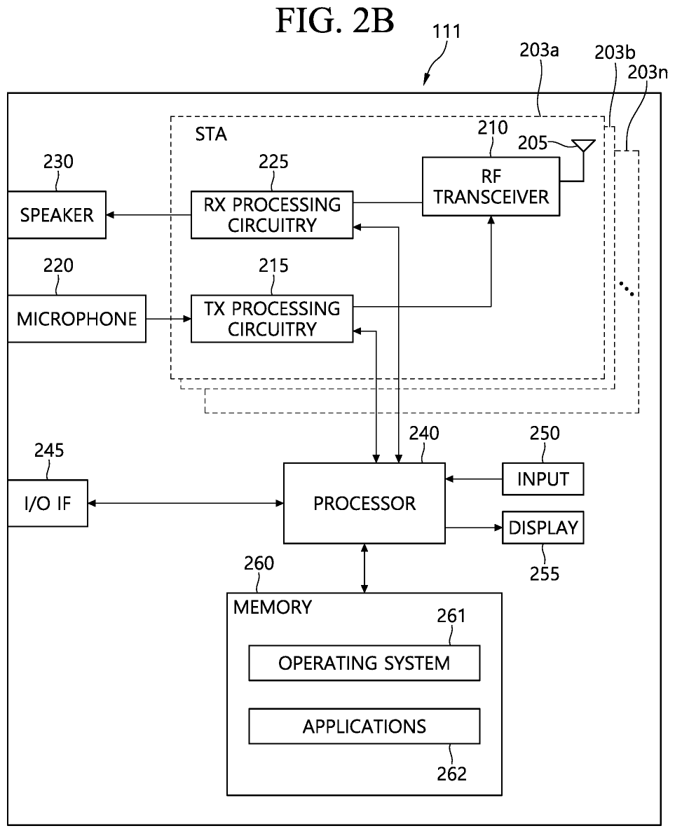

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

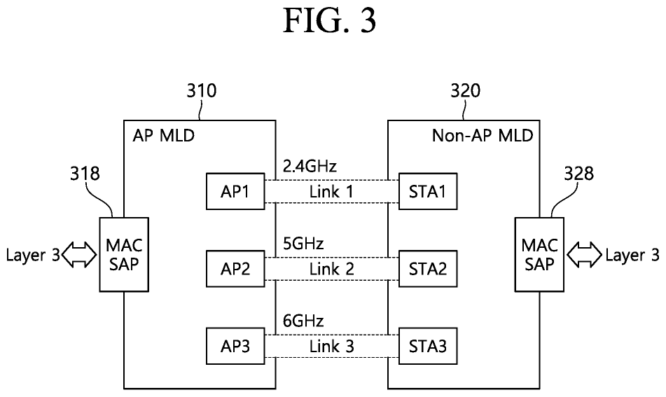

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

In recent times there has been a growing need for emergency services over Wi-Fi networks. In IEEE 802.11be, Emergency Preparedness Communication Services (EPCS) has been introduced with the goal of providing prioritized access to certain authorized users. As a part of this service, a user associated with an AP can be authorized by the AP to take advantage of EPCS service. Once authorized, the user can use an enhanced Enhanced Distributed Channel Access (EDCA) parameter set with values for parameters such as Minimum Contention Window (CWmin[AC]), Maximum Contention Window (CWmax[AC]), Arbitration Inter-Frame Spacing (AIFSN[AC]), or Transmission Opportunity Limit (TXOP[AC]), among others, which are different from those for other STAs associated with the same AP. With this enhanced EDCA parameter set, a non-AP MLD that is authorized by an AP can benefit from prioritized access as it can capture a channel faster compared to other users in the network. After EPCS is disabled, the non-AP MLD can update its EDCA parameter set to a normal EDCA parameter set, which can match that of other non-EPCS users in the network.

Many embodiments can provide fast authorization for Emergency Preparedness Communication Services (EPCS) in wireless networks. In many embodiments a non-AP MLD may need to be authorized by the EPCS authorization framework (e.g., subscription service provider network (SSPN) interface, EPCS AP MLD, among others) in order to obtain EPCS priority access. In many embodiments, an EPCS authorization status of one or more non-AP MLDs associated with an EPCS AP MLD may be updated dynamically during run-time. Wireless systems that may use dynamic run-time updates may experience various lag time issues regarding non-AP MLDs that may be operating with an outdated status. In particular, a non-AP MLD can be operating with an outdated authorization status until an EPCS AP MLD is able to inform the non-AP MLD about its updated status.

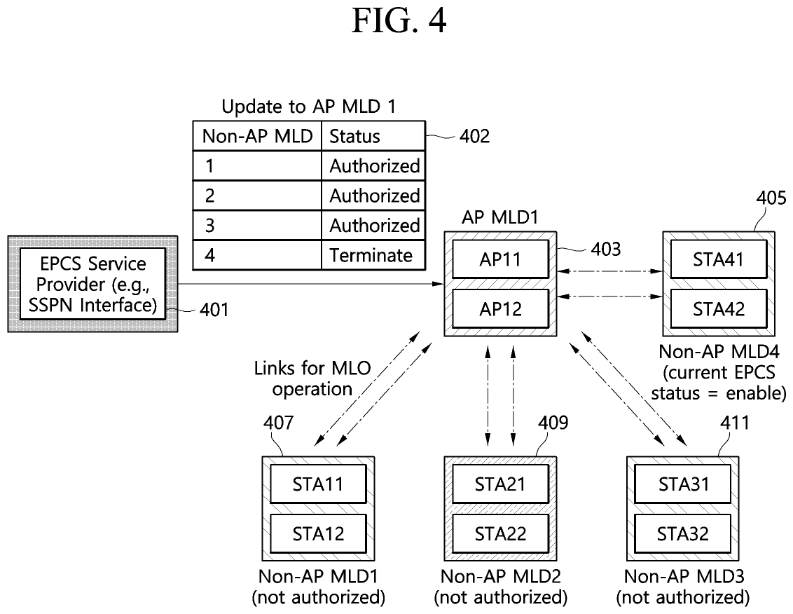

FIG. 4 illustrates an example EPCS communications in accordance with an embodiment. In particular, the example in FIG. 4 illustrates an example a dynamic run-time update and a non-AP MLD having an outdated authorization status due to a lag time in receiving the updates.

FIG. 4 illustrates an example EPCS authorization framework scenario, whereby EPCS subscribers may need to use an application (e.g., video conference). In EPCS, subscribers may use an enterprise's managed wireless access network for communication and the wireless network may become congested with competing traffic. Accordingly, a subscriber may invoke EPCS on the enterprise's wireless network, whereby priority access may be enabled and the subscriber may obtain higher priority over other users in the network. EPCS features have been defined in IEEE 802.11be as an on-demand capability that may allow APs to authorize non-AP STAs to communicate with a higher priority.

As illustrated in FIG. 4, an EPCS service provider 401 that can be a service provider that can provide an authorization status 402 to an EPCS AP MLD denoted by AP MLD1 403. The authorization status 402 can include a non-AP MLD identifier and a status of the AP MLD (e.g., authorized/enabled, terminate/disabled, among others).

The AP MLD1 403 can be associated with a number of non-AP MLDs, including non-AP MLD1 407, non-AP MLD2 409, non-AP MLD 3 411, non-AP MLD4 405. As illustrated, currently the non-AP MLDs 407, 409 and 411 have a status of “not authorized” (disabled) meaning they do not have an EPCS authorized status as the EPCS service provider 401 has not given them authorization to make use of the EPCS service. Accordingly, even if any non-AP MLD 407, 409, or 411 is an EPCS capable STA device, it cannot request for EPCS service because it is not authorized. Furthermore, non-AP MLD4 405 has a current EPCS status of “enabled” and can thus use the EPCS service.

At a later time, the EPCS service provider 401 can provide an updated authorization status 402 to the AP MLD1 403. The updated authorization status 402 can include, at a same time, a status of the several non-AP MLDs. In an embodiment, the updated status indicates an authorization status change to “authorized” (enabled) for non-AP MLDs 407, 409, and 411, and “terminate” (disabled) for non-AP MLD4 405, as illustrated in the updated authorization status 402 which includes authorization status of non-AP MLD “1”, “2” and “3” as “authorized” and Non-AP MLD “4” as “terminate”. After the updated authorization status 402 is received from the EPCS service provider 401, the EPCS AP MLD1 403 can provide the update authorization status 402 to the non-AP MLDs 405, 407, 409, 411 about their status change. In many embodiments, the updated authorization status can be communicated using an unsolicited status update technique, and it can take some time before the EPCS AP MLD 403 has informed all the concerned non-AP MLDs 405-411 about their authorization status change, which can either provide or terminate EPCS priority access to them.

Accordingly, during the duration of time required by the AP MLD 403 to provide the updated authorization status to the non-AP MLDs, some of the non-AP MLDs may be operating with an outdated authorization status. For example, AP MLDs 407, 409 and 411, who may not have received their updated authorization status regarding their EPCS authorization status can still continue to operate without EPCS priority access even though they have been authorized. For example, these non-AP MLDs operate with EPCS priority access in a disabled state. In particular, non-AP MLD1 407, non-AP MLD2 409, and non-AP MLD3 411 can continue to operate in the non-authorized state even though their status has been updated to authorized/enabled in the update to AP MLD 1 402.

Likewise, a number of non-AP MLDs, such as non-AP MLD4 405 may be previously authorized for EPCS priority access and can be operating in EPCS authorization state set to an enabled state. The service provider can terminate (disable) their EPCS priority access authorization status. After their authorization state has been disabled, it can take some time before the EPCS AP MLD1 403 has informed the concerned non-AP MLDs, including non-AP MLD4 405, about their authorization status being disabled. During this time, the non-AP MLDs (e.g., non-AP MLD4 405), who have not yet received the status update regarding their EPCS authorization status, can continue to operate with EPCS priority access in the enabled state and thus can unfairly get priority access even though their status has been disabled.

As such, a lag time that may occur between a time that an authorization status for one or more non-AP MLD is updated and the time at which the updated authorization is actually received at the effected one or more non-AP MLD. Many embodiments can minimize this lag time by providing, by an AP MLD, the authorization status update to the multiple non-AP MLDs at a same time or within a short time window. In particular, in many embodiments, an AP MLD can transmit frames related to an authorization status with a higher priority over other frame transmissions, which can reduce the lag time regarding updating a status of a non-AP MLD.

In many embodiments, EPCS priority access can provide prioritized channel access for EPCS authorized non-AP MLD(s) which can increase the non-AP MLDs probability of successful communication.

In many embodiments, when a non-AP MLD is authorized for EPCS, the non-AP MLD may also be running non-EPCS related applications. However, currently there are no procedures to differentiate the traffic of EPCS applications and the traffic that of non-EPCS applications. In particular, many embodiments may provide prioritized channel access to traffic that originates from an EPCS authorized device. However, this may unfairly provide prioritized channel access to non-EPCS traffic. In particular, if there are one or more non-AP MLDs that have a high load of non-EPCS traffic with a sparse low load EPCS traffic, the non-EPCS traffic can cause congestion and/or higher delays for EPCS traffic of other non-AP MLDs which can have only EPCS traffic. This can also affect the performance of EPCS traffic from such non-AP MLDs. Furthermore, even for the non-AP MLDs that have a high load of non-EPCS traffic coupled with low load EPCS traffic, the EPCS traffic can suffer additional delays as the non-EPCS traffic queued prior to it may get served. In particular, the EPCS traffic may be served with the same priority level as the non-EPCS traffic. Accordingly, many embodiments provide for differentiating EPCS traffic from non-EPCS traffic.

In many embodiments, an EPCS AP MLD can transmit a status update frame in a unicast manner upon receiving an authorization status update, for example, from an SSPN interface. In many embodiments, the authorization status can be transmitted in an unsolicited manner. In certain embodiments, the authorization status can be transmitted in an on-demand manner, for example, when demanded by a non-AP device. In several embodiments, the authorization status can be transmitted periodically among other types of transmission as appropriate to the requirements of specific applications.

In many embodiments, a transmission of EPCS authorization status frames can be given higher priority over transmission of frames that do not provide an EPCS authorization status unless they are essential for BSS operation (e.g., beacon frames, among others).

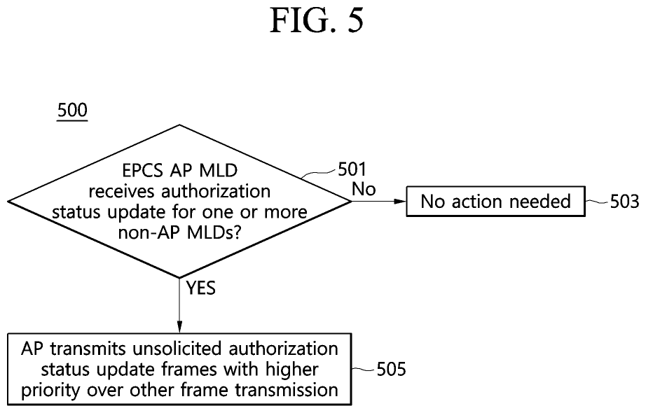

FIG. 5 illustrates a flow chart of an example process for unicast authorization status updates in accordance with an embodiment. The process 500 can begin in operation 501 where the AP MLD (e.g., an EPCS AP MLD) determines whether it receives an EPCS authorization status update for one or more non-AP MLDs. If the AP MLD determines that it has not received an EPCS authorization status update, the process proceeds to operation 503 where no action is necessary. If the AP MLD determines that it has received an EPCS authorization status update, the process proceeds to operation 505 where the AP can transmit to one or more non-AP MLDs one or more unsolicited EPCS authorization status update frames with higher priority over other frame transmissions. In many embodiments, an EPCS authorization status update frame can include enhanced EDCA parameters that prioritize transmission over frames with normal EDCA parameters.

In many embodiments, the unicast authorization update can be made in an independent frame or via other types of frames defined in IEEE 802.11 standard (e.g., EPCS priority access enable request frame, EPCS priority access enable response frame, EPCS priority access teardown frame, among others).

In many embodiments, the EPCS authorization status of one or more non-AP MLDs can be updated by the AP MLD at the same time.

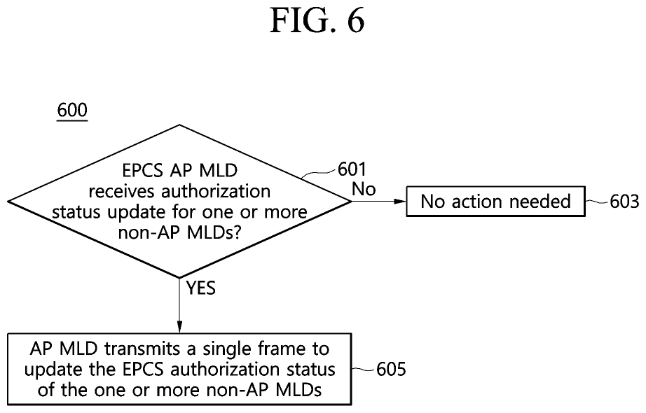

FIG. 6 illustrates a flow chart of an example process of an AP MLD updating the EPCS authorization status in accordance with an embodiment. In the example of FIG. 6, the AP MLD updates the EPCS authorization status for multiple non-AP MLDs at the same time. As illustrated in FIG. 6, the process can begin in operation 601 where the AP MLD (e.g., EPCS AP MLD) can determine whether it receives an EPCS authorization status update for one or more non-AP MLDs. If the AP MLD has not received the EPCS authorization status update, the process proceeds to operation 603 where no action is needed. If the AP MLD has received an EPCS authorization status update, the process proceeds to operation 605 where the AP MLD transmits a single frame to update the EPCS authorization status of the one or more non-AP MLDs at the same time. In many embodiments, the update can be made by the AP MLD by transmitting a single frame to the non-AP MLDs. The frame transmitted by the AP MLD can include one or more of the information items indicated in Table 1.

TABLE 1
Information items that can be present in an authorization
status update frame transmitted by an AP MLD

| Information item | Description |
|---|---|
| Non-AP MLD/STA | Information identifying the non-AP MLDs/non-AP STAs whose |
| identifier | authorization status is being updated. e.g., MAC address, among |
| | others |
| Category | Action field category definition (e.g., EHT, among others) |
| Protected EHT | Defining the type of action that is being requested (e.g., EPCS |
| Action | priority access enable request, among others) |
| Dialog Token | A token for matching the action responses with the action requests. |
| Reason code | A reason code stating the reason for sending the frame (e.g., EPCS |
| | authorization status update, among others). |
| Status code | The authorization status. (e.g., a status code to indicate that the EPCS |
| | authorization has been terminated) These status codes can be a list |
| | with each status code arranged in the same order as the non-AP |
| | MLD/STA identifier list order. Thus, there can be a one to one |
| | mapping between the status code and the non-AP MLD/STA |
| | identifier. This can enable the AP MLD to both authorize and |
| | terminate the EPCS status of multiple non-AP MLDs at the same |
| | time. |
| EPCS operation | The operation parameters for EPCS functioning. (e.g., the enhanced |
| parameters | EDCA parameter set that the non-AP MLD can use if it is authorized |
| | for EPCS) |
| Priority access | The priority access multi-link element or one or more of the |
| multi-link element | information items described herein. |

In many embodiments, the information can be transmitted by the EP P MLD to the non-AP MLD in an independent frame and/or via other types of frames defined in a standard (e.g., EPCS priority access enable request frame, EPCS priority access enable response frame, EPCS priority access teardown frame, among others). In many embodiments, the information can be transmitted in a unicast, multicast and/or broadcast manner.

In many embodiments, the update authorization status frame can be transmitted with the same priority as other EPCS priority related frames in the standard (e.g., EPCS priority access enable request frame, EPCS priority access enable response frame, EPCS priority access teardown frame, among others). In many embodiments, the update authorization status frame can be given higher priority as compared to other frames that the AP MLD may need to transmit unless those frames are necessary to be transmitted for BSS operation (e.g., beacon frames, among others).

In many embodiments, upon receiving the update authorization status frame from the AP MLD, the non-AP MLD can update its EPCS authorization status.

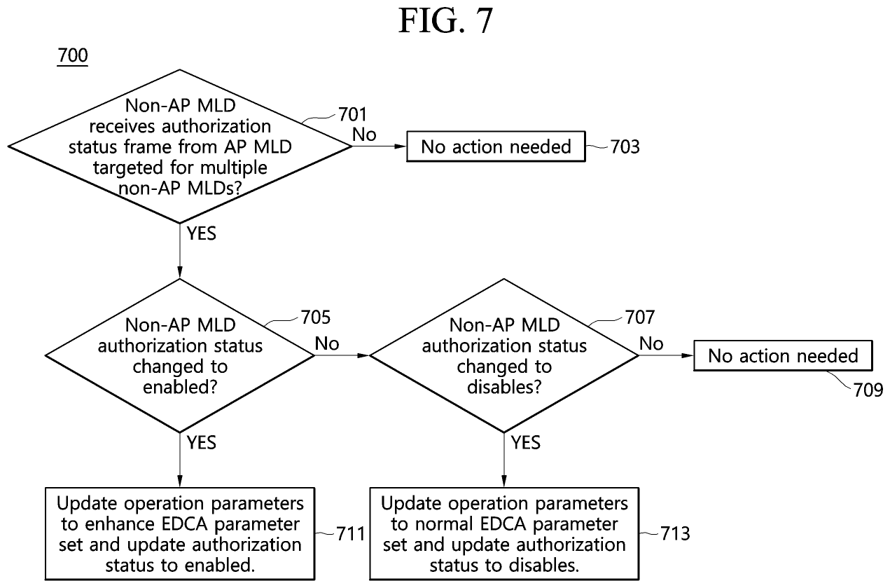

FIG. 7 illustrates a flow chart of an example process of a non-AP MLD receiving update authorization status frames from an EPCS AP MLD to update its EPCS authorization status in accordance with an embodiment.

The process 700 begins in operation 701 where the non-AP MLD can determine whether it receives an update authorization status frame from an AP MLD targeted for multiple non-AP MLDs. If the non-AP MLD determines that it has not received the update authorization status frame, the process proceeds to operation 703 where no action is needed. If the non-AP MLD determines that it has received the update authorization status frame, the process proceeds to operation 705 where the non-AP MLD determines whether its authorization status has changed to enabled. If the non-AP MLD determines that its authorization status has not been changed to enabled, the process proceeds to operation 707 where the non-AP MLD determines whether its authorization status has been changed to disabled. If the non-AP MLD determines that its authorization status has not been changed to disabled, the process proceeds to operation 709 where no action is needed.

If the non-AP MLD determines that its authorization status has changed to enabled, the process proceeds to operation 711 where the non-AP MLD updates its operation parameters to an enhanced EDCA parameter set and updates its authorization status to enabled. In many embodiments, the non-AP MLD can use an EPCS operation parameters that are provided by the AP MLD.

If the non-AP MLD determines that its authorization status has changed to disabled, the process proceeds to operation 713 where the non-AP MLD updates its operation parameters to a normal EDCA parameter set and updates its authorization status to disabled. In many embodiments, the non-AP MLD can update its EPCS operation parameters to the normal operation parameters being used by other non-EPCS non-AP MLDs in the network.

In many embodiments, an EPCS AP MLD can locally cache EPCS authorization status information. This information can include, but is not limited to, a previous EPCS authorization that the AP MLD may have performed for a non-AP MLD(s) (e.g., authorization status information present in Table 1 and Table 2 described herein, among other information). In many embodiments, the AP MLD can pass this information to other AP MLD(s) for the purpose of mobility management. Accordingly, when the authorization status of one or more non-AP MLD(s) is updated by the EPCS service provider (e.g., the SSPN interface), the AP MLD can transmit a frame to the other AP MLD(s) that it is sharing information with in order to update the information at those AP MLD(s). In some embodiments, the information can be stored in the local cache of the sharing AP MLD).

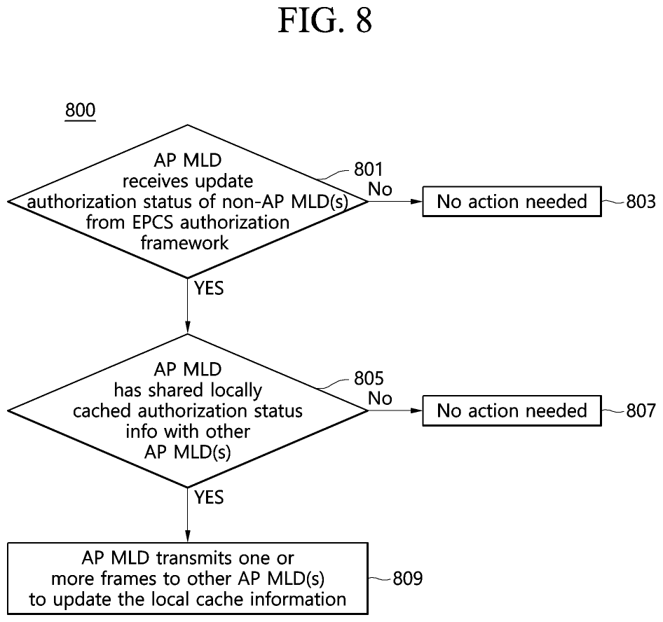

FIG. 8 illustrates a flow chart of an example process for a local cache update for an AP MLD in accordance with an embodiment. The process 800 can begin in operation 801 where the AP MLD determines whether it has received an updated authorization status of non-AP MLD(s) from an EPCS service provider. If the AP MLD determines that it has not received an updated authorization status, the process proceeds to operation 803 where no action is needed. If the AP MLD determines that it has received an updated authorization status, the process proceeds to operation 805 where the AP MLD determines whether it has shared locally cached authorization status information with other AP MLD(s). If the AP MLD determines that it has not shared locally cached authorization status information with other AP MLD(s), the process proceeds to operation 807 where no action is needed.

If the AP MLD determines that it has shared locally cached authorization status information with other AP MLD(s), the process proceeds to operation 809 where the AP MLD transmits one or more frames to other AP MLD(s) to update the local cache information.

In many embodiments, a cache update frame can include one or more of the information fields indicated in Table 2.

TABLE 2
Information fields that can be present in a
cache update frame transmitted by the AP MLD

| Information item | Description |
|---|---|
| AP identifier | Identifier for the AP MLD(s) for whom this update is intended. e.g., |
| | the AP MAC address. |
| STA identifier | Identifier for the non-AP MLD(s) whose information is being |
| | updated. e.g., the non-AP MLD MAC address. |
| Local cache | The information from the local cache that was previously shared and |
| information | now needs to be updated. e.g., the updated EPCS authorization state |
| | of the non-AP MLD (enable/torn down). |

One or more information from table 2 can be transmitted in an independent frame or in other types of frames defined in IEEE 802.11 standard (e.g., frames for inter-AP communication, among others). In many embodiments, the information can be transmitted over the air and/or over the wired backhaul network connecting the AP MLDs.

In many embodiments, there may be communication between AP MLDs such that upon receiving an updated authorization status from another AP MLD, a receiving AP MLD can update its local cache with the updated information transmitted by the AP MLD.

Many embodiments can include a capability advertisement regarding whether an AP MLD supports a capability to update an EPCS status of multiple non-AP STAs together. In many embodiments, an AP MLD that supports cache updates can advertise this to non-AP MLDs in one or more frames that it transmits. These frames can be independent frames and/or other types of frames in IEEE 802.11 standard (e.g., management frames such as beacons, among others).

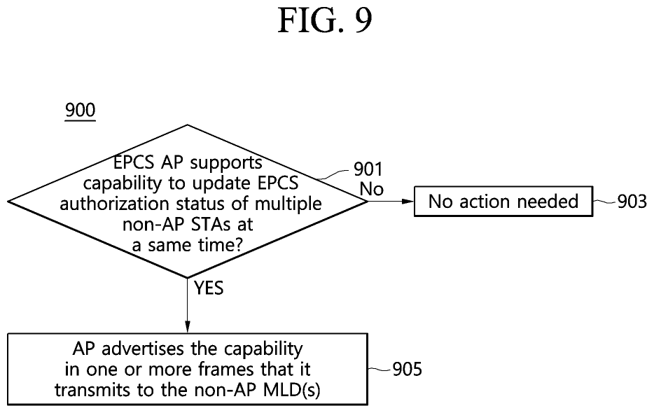

FIG. 9 illustrates a flow chart of an example process for an AP MLD to advertise a capability regarding supporting updates to EPCS authorization status of multiple non-AP STAs. The process 900 begins in operation 901 where the AP MLD determines whether it supports a capability to update EPCS authorization status of multiple non-AP STAs at a same time. If the AP MLD determines that it does not support the capability to update the EPCS authorization status of multiple non-AP STAs, the process proceeds to operation 903 where no action is needed.

If the AP MLD determines that it does support a capability to update the EPCS authorization status of multiple non-AP STAs at a same time, the process proceeds to operation 905 where the AP advertises the capability in one or more frames that it transmits to the non-AP MLD(s). In many embodiments, when a non-AP MLD receives a frame from an AP MLD, it can identify a cache update capability supported by the AP MLD.

Many embodiments can provide differentiation of EPCS and non-EPCS traffic based on classification criteria. In some embodiments, a non-AP MLD that is authorized for EPCS priority access can provide classification criteria information to the AP MLD that it is associated with to help the AP MLD differentiate between EPCS traffic and non-EPCS traffic.

In many embodiments, an AP can use a classifier mask that can include the classification criteria to use to differentiate between the EPCS traffic and non-EPCS traffic. In some embodiments, the mask may be a one or more parameters that may be used to classify frames into specific streams, including classifying frames as including EPCS traffic or non-EPCS traffic. In some embodiments, a classifier mask may be data that is used for bitwise operations. In many embodiments, the classifier mask can be designed by using a TCLAS (traffic classification) element and the TCLAS processing element. The frame classifier field inside the TCLAS element can be used to specify the criteria for classification. In many embodiments, one or more criteria can be created and the TCLAS processing element can be used to specify how to use these criteria jointly. The non-AP MLD can provide the classifier mask to the AP MLD and the AP MLD can use the classifier mask to perform the differentiation.

In many embodiments, the non-AP MLD can transmit a frame to the AP MLD to provide the classification mask to the AP MLD.

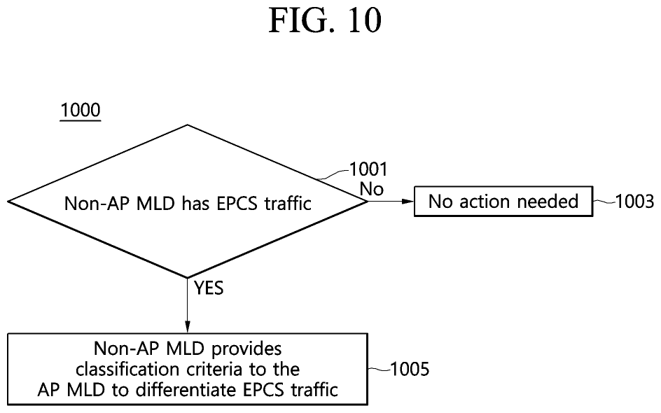

FIG. 10 illustrates a flow chart of an example process on a non-AP MLD providing classification criteria in accordance with an embodiment. The process 1000 can begin in operation 1001 where the non-AP MLD can determine whether it has EPCS traffic. If the non-AP MLD determines that it does not have EPCS traffic, the process proceeds to operation 1003 where no action is needed. If the non-AP MLD determines that it does have EPCS traffic, the process proceeds to operation 1005 where the non-AP MLD can provide classification criteria to the AP MLD to differentiate EPCS traffic. In many embodiments, the non-AP MLD can transmit one or more frames during and/or before the EPCS authorization procedure to provide the classification mask to the AP MLD. In many embodiments, the non-AP MLD can perform updates to the classification criteria by transmitting updated classification criteria to the AP MLD after EPCS authorization procedure is complete.

In many embodiments, a frame transmitted by the non-AP MLD can include one or more of the information items indicated in Table 3.

TABLE 3
Information items that can be present in the frame transmitted by
the non-AP MLD to the AP MLD for providing classification criteria.

| Information item | Description |
|---|---|
| Identifier | An identifier for the classification criteria. This identifier can be used |
| | by the non-AP MLD when referring to a particular classification |
| | criterion that it provides to the AP MLD. Thus, in its communication, |
| | the AP MLD can know which classification criteria the non-AP MLD |
| | is referring to. If the non-AP MLD makes an update to the |
| | classification criteria, the non-AP MLD can do so using this identifier |
| | as the reference. This identifier can be provided to the AP MLD in |
| | various different forms. e.g., it can be an alphanumeric value, an |
| | integer value, among others. |
| Classification | The classification criteria to be used to differentiate EPCS traffic from |
| criteria | non-EPCS traffic. e.g., this can be provided by using the TCLAS and |
| | the TCLAS processing element, among others. |
| Non-AP MLD | The identifier of the non-AP MLD. e.g., MAC address, among other |
| identifier | identifiers. |
| AP MLD identifier | The identifier of the AP MLD. e.g., MAC address, among other |
| | identifiers. |
| Token | A token to refer to the classification criteria frame. |
| Action | Action that AP MLD needs to take. e.g., replace an old classification |
| | criteria with a new classification criteria, add additional criteria to |
| | classification criteria, among others. |

The criteria classification information can be transmitted by the non-AP MLD in an independent frame and/or in other types of frames of IEEE 802.11 standard (e.g., EPCS priority access enable request frame, EPCS priority access enable response frame, among others).

In many embodiments, the non-AP MLD can provide more than one classification criterion to define more than one sub-category within EPCS traffic and each category can be assigned different priority access levels by the AP MLD.

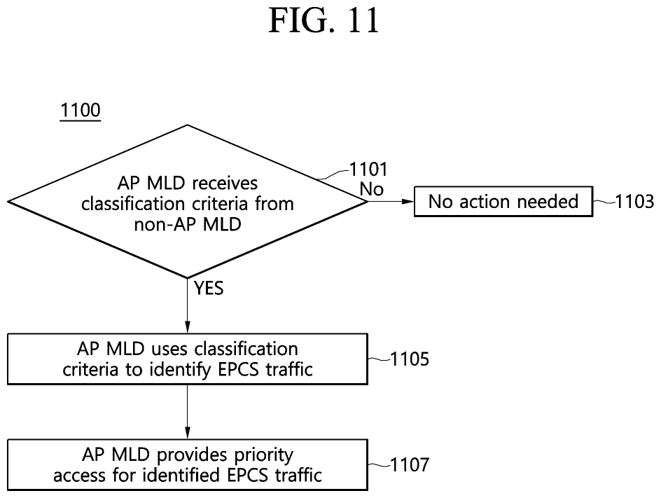

In many embodiments, when the AP MLD receives classification criteria from a non-AP MLD, the AP MLD can use that classification criteria to identify EPCS traffic and provide it with priority access for transmission. FIG. 11 illustrates a flow chart of an example process of an AP using classification criteria to differentiate traffic in accordance with an embodiment.

The process 1100 can begin in operation 1101 where the AP MLD determines whether it receives classification criteria from a non-AP MLD. If the AP MLD determines that it has not received classification criteria from a non-AP MLD, the process proceeds to operation 1103 where no action is needed.

If the AP MLD determines that it has received classification criteria from a non-AP MLD, the process proceeds to operation 1105 where the AP MLD uses the classification criteria to identify EPCS traffic. In operation 1107, the AP MLD provides priority access for the identified EPCS traffic.

In many embodiments, when the AP MLD receives an update to the classification criteria provided by the non-AP MLD, the AP MLD can update the classifier mask that it uses for EPCS traffic differentiation and to modify/replace the old mask.

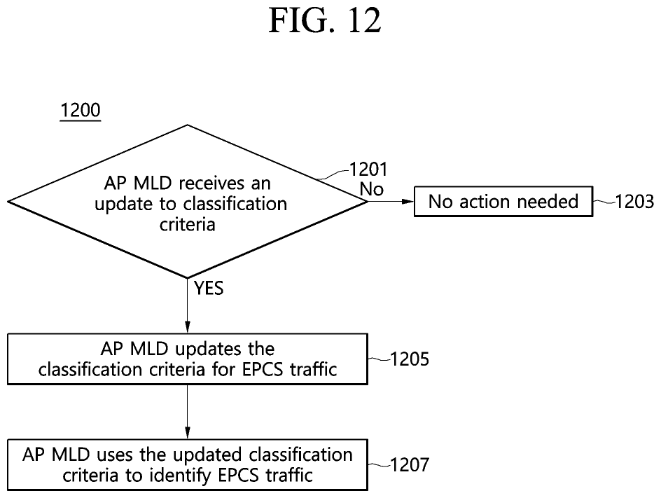

FIG. 12 illustrates a flow chart of an example process of an AP MLD updating classification criteria in accordance with an embodiment.

The process 1200 can begin in operation 1201 where the AP MLD determines whether it receives an update to classification criteria. If the AP MLD determines that it has not received an update to classification criteria, the process proceeds to operation 1203 where no action is needed.

If the AP MLD determines that it has received an update to the classification criteria, the process proceeds to operation 1205 where the AP MLD updates the classification criteria for EPCS traffic. In operation 1207, the AP MLD uses the updated classification criteria to identify EPCS traffic.

In many embodiments, when the non-AP MLD provides AP MLD with different classification criteria to create sub-categories within EPCS traffic, the AP MLD can provide different EPCS operation parameters (e.g., enhanced EDCA parameter set) to each sub-category if it supports service based EPCS operation. In certain embodiments, the AP MLD can provide the same enhanced EDCA parameter set to all the sub-categories.

Many embodiments can differentiation EPCS and non-EPCS traffic using traffic identifier information. In particular, in many embodiments, the non-AP MLD can provide a traffic identifier (e.g., TID, among others) to the AP MLD to assist the AP MLD in identifying EPCS traffic. In many embodiments, if EPCS traffic generated by the non-AP MLD predominantly contains frames of a certain set of TIDs, then the non-AP MLD can provide that set of TIDs to the AP MLD.

In many embodiments, to provide a TID indication, the non-AP MLD can provide a TID bitmap to the AP MLD in a frame that can include one or more of the information items described in Table 3 (with the addition of TID bitmap). In the TID bitmap, the bit corresponding to the TIDs that can belong to EPCS traffic can be set to 1 and the remaining can be set to 0.

Many embodiments can differentiate EPCS and non-EPCS traffic using service ID information. In particular, in many embodiments, a service identifier can be defined by the service provider. The service ID can be provided to the AP MLD and the non-AP MLD by the service provider infrastructure for EPCS support. Accordingly, EPCS traffic can be identified by the AP MLD and the non-AP MLD based on this service identifier.

Accordingly, many embodiments can an ability of an AP MLD in identifying EPCS traffic for a non-AP MLD. In many embodiments, traffic that is identified as non-EPCS traffic can continue to use normal operation parameters (e.g., normal EDCA parameter set) advertised by the AP MLD for non-AP MLDs that are not EPCS authorized.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device in a wireless network, the AP device comprising:
a memory;
a processor coupled to the memory, the processor configured to:
receive an emergency preparedness communication services (EPCS) authorization status for one or more station (STA) devices; and
transmit a frame including the EPCS authorization status to the one or more STA devices, wherein the frame has higher priority for transmission than a frame for non-EPCS.

2. The AP device of claim 1, wherein Enhanced Distributed Channel Access (EDCA) parameters of the frame including the EPCS authorization status have a higher priority than EDCA parameters of the frame for non-EPCS.

3. The AP device of claim 1, wherein the frame including the EPCS authorization status is simultaneously transmitted to the one or more STA devices.

4. The AP device of claim 1, wherein the EPCS authorization status indicates accessibility to the EPCS for the one or more STA devices.

5. The AP device of claim 1, wherein the processor is configured to:
locally store the EPCS authorization status; and
transmit the EPCS authorization status to one or more other AP devices.

6. The AP device of claim 1, wherein the processor is configured to advertise, to the one or more STA devices, a capability to simultaneously update EPCS authorization status for multiple STA devices.

7. The AP device of claim 1, wherein the processor is configured to:
receive classification criteria that classify EPCS traffic from non-EPCS traffic from an STA device; and
transmit a frame including EPCS traffic to the STA device, wherein the frame has a higher priority for transmission than a frame for non-EPCS traffic.

8. The AP device of claim 7, wherein the classification criteria comprise a traffic identifier (TID) or a service identifier.

9. The AP device of claim 1, wherein the EPCS authorization status is received from an EPCS service provider.

10. A station (STA) device in a wireless network, the STA device comprising:
a memory;
a processor coupled to the memory, the processor configured to:
receive a frame including an EPCS authorization status from an access point (AP) device, wherein the frame has higher priority than a frame for non-EPCS;
determine the EPCS authorization status enables access to the EPCS; and
transmit a frame that includes EPCS traffic to the AP device, wherein the frame has higher priority for transmission than a frame for non-EPCS traffic.

11. The STA device of claim 10, wherein Enhanced Distributed Channel Access (EDCA) parameters of the frame including the EPCS traffic have a higher priority than EDCA parameters of the frame for non-EPCS traffic.

12. The STA device of claim 10, wherein the processor is configured to:
receive another frame including an updated EPCS authorization status from the AP device, wherein the updated EPCS authorization status disables access to the EPCS; and
transmit frames that has the same priority for transmission as the frame for non-EPCS traffic.

13. The STA device of claim 10, wherein the processor is configured to transmit classification criteria that classify EPCS traffic from non-EPCS traffic to the AP device.

14. A computer-implemented method for facilitating communication in a wireless network, the method comprising:
receiving an emergency preparedness communication services (EPCS) authorization status for one or more station (STA) devices; and
transmitting a frame including the EPCS authorization status to the one or more STA devices, wherein the frame has higher priority for transmission than a frame for non-EPCS.

15. The computer-implemented method of claim 14, wherein Enhanced Distributed Channel Access (EDCA) parameters of the frame including the EPCS authorization status have a higher priority than EDCA parameters of the frame for non-EPCS.

16. The computer-implemented method of claim 14, wherein the frame including the EPCS authorization status is simultaneously transmitted to the one or more STA devices.

17. The computer-implemented method of claim 14, wherein the EPCS authorization status indicates accessibility to the EPCS for the one or more STA devices.

18. The computer-implemented method of claim 14, further comprising:
locally storing the EPCS authorization status; and
transmitting the EPCS authorization status to one or more other AP devices.

19. The computer-implemented method of claim 14, further comprising advertising, to the one or more STA devices, a capability to simultaneously update EPCS authorization status for multiple STA devices.

20. The computer-implemented method of claim 14, further comprising:
receiving classification criteria that classify EPCS traffic from non-EPCS traffic from the at least one STA device; and
transmitting a frame including EPCS traffic to the at least one STA devices, wherein the frame has a higher priority for transmission than a frame for non-EPCS traffic.
